(19) United States
(12) Patent Application Publication
(10) Pub. No.: US 2010/0111628 A1
(43) Pub. Date: May 6, 2010

(54) Method for Designing and Manufacturing a Gear

(75) Inventors: Wilhelmus Johannes Theodorus Megens, Berkel-Enschot (NL); Arnoldus Nicolaas Josephus Van Roosmalen, Berkel-Enschot (NL)

Correspondence Address: THE WEBB LAW FIRM, P.C., 700 KOPPERS BUILDING, 436 SEVENTH AVENUE, PITTSBURGH, PA, 15219, US

(73) Assignee: HPG NEDERLAND B.V., Tilburg (NL)

(21) Appl. No.: 12/530,244

(22) PCT Filed: Apr. 26, 2008
(86) PCT No.: PCT/NL08/50257

§ 371 Date: Sep. 8, 2009

(30) Foreign Application Priority Data
Apr. 26, 2007 (NL) 2000617

(51) Int. Cl. B23F 9/08; B23F 5/20; B23H 1/00

(52) U.S. Cl. 409/26; 409/27; 219/69.17; 219/69.11

(57) ABSTRACT

A method for designing and manufacturing a gear by means of a computer-controlled machining device comprises the following steps of using a machining device adapted to perform an operation from the group including: milling and spark eroding; using a tool, in particular a milling device or a spark erosion head; using a machining device of the type with at least five simultaneous, independent degrees of freedom; and applying an elongate tool, the form of which corresponds at least to some extent with the intended form of surfaces for modeling by machining.

The invention lies in the field of designing and manufacturing a gear.

Gears are complex three-dimensional bodies. The purpose of a high-grade gear transmission, comprising at least two gears, is a uniform transfer of movement without relative slip or other forms of power loss with, also at high load and high rotational speeds, vibrations, and with a low sound production. Such gears are usually manufactured using milling or cutting techniques.

Milling machines intended to satisfy the requirements set for a gear have been commercially available for a long time. All these known machines are based on the realization of a tooth form corresponding to, or at least based on the form of an involute.

Using such machines an involute tooth form, particularly in the case of a cylindrical gear, can be manufactured easily by milling or cutting by imposing a uniform movement on a gear rack blade or a needle blade along the pitch circle of the designed gear which, with a view hereto, rotates in the correct manner, in particular at the correct chosen speed. A precise involute, and thereby a gear precisely meeting the set specification, is thus created in a cylindrical gear with straight toothing.

Another method of producing gears with a tooth form based on an involute makes use of a hob. In this case the rotating hob is displaced uniformly through the likewise rotating gear material.

In accordance with yet another production method, a profile grinding disc grinds the tooth form into the gear material, wherein the tooth form is pre-arranged in the profile disc milling device.

In addition to cylindrical gears with straight teeth, angled teeth or with double-angled teeth (V-toothing), cone-shaped gears are also applied with straight or angled teeth or with a toothing in which the tooth angle varies over the tooth width. Quadrants thus result which in practice have concave or convex forms and which are formed as part of a circle, a cycloid, an involute, a palloid or epicycloid. In addition to the above described cylindrical and cone-shaped gears, conical or bevel gears are also applied. These are gears in which the axes in question do not extend mutually parallel.

All the above described involute tooth forms are the result of movements anchored in special gear milling machines of the machining tool and those of the gear for manufacturing relative to each other. The tooth form and the quadrant of all these gears are thus anchored kinematically in the machine with which the gear is manufactured, as well as in the form of the tool used.

Although use continues to be made of the involute from a circle in the flat plane (basic starting point for cylindrical gears) in the case of bevel gears this involute is as it were projected onto a three-dimensional conical body, from which projection a spherical involute is now created in the spatial plane. Inherently to the production method of the bevel gear, there do however occur significant differences relative to the intended spherical involute tooth sections in the case of cone-shaped gears. Owing to these deviations a tooth form is not created on the basis of a spherical involute, but a tooth form based on an octoid, whereby it is no longer possible to fully satisfy the above stated condition of a uniform transfer of movement, which adversely affects the running properties of a transmission with two or more such gears. Reference is made to:
Dr. Herman J. Stadfeld: “The basics of Spiral Bevel Gears”, January/February 2001 Gear Technology pp. 31-38.
G. Niemann, H. Winter, Maschinelemente Band III, pp. 26-27.

In the case of bevel gears an improvement can be realized by no longer making use of fixed, kinematically defined machine-tool combinations, whereby a tooth form deviating from the spherical involute results, but by making use of freely programmable combinations with which precise spherical involute tooth forms can be realized by means of machining.

Initiatives in this direction are known, amongst others from publications of studies by Figliolini, Özal and Suh. Reference is made for this purpose to the references cited below. Figliolini has for instance published a universal mathematical description of a gear with spherical involute teeth, whereby the universal description of the mathematical model of a bevel gear is also known. On the basis of these mathematical models the possibility is created of also realizing complex cone-shaped gears by means of machining using freely programmable machine-tool combinations, and based on a spherical involute.

Such machines must of course have sufficient degrees of freedom to be able to realize the complex tooth forms of bevel gears.

For the milling of bevel gears in such a manner use is now made in all cases of triaxial, simultaneously operating milling machines. An additional turntable is thus applied, whereby a quadraxial milling machine is essentially created. During the milling itself this turntable, which provides an extra degree of freedom, is however fixed so that this is then essentially also a triaxial, simultaneously operating milling machine.

Such milling machines make use of a spherical milling device with a small diameter for the milling, so that sufficient freedom of movement is still also available on the underside of the tooth root.

The advantage of using a spherical milling device is that it makes no difference at which angle the milling device contacts the surface for milling, with the limitation of course that the needle of the milling device may not contact the tooth surface and that the underside of the spherical milling device, where the cutting sides meet, cannot be used for milling.

The milling machine to be used therefore theoretically only has to provide the possibility of reaching each small x-, y- and z-position on the bevel gear in space, wherein the position of the needle of the milling device is not relevant. This can be realized with a relatively simple, freely programmable triaxial milling machine.

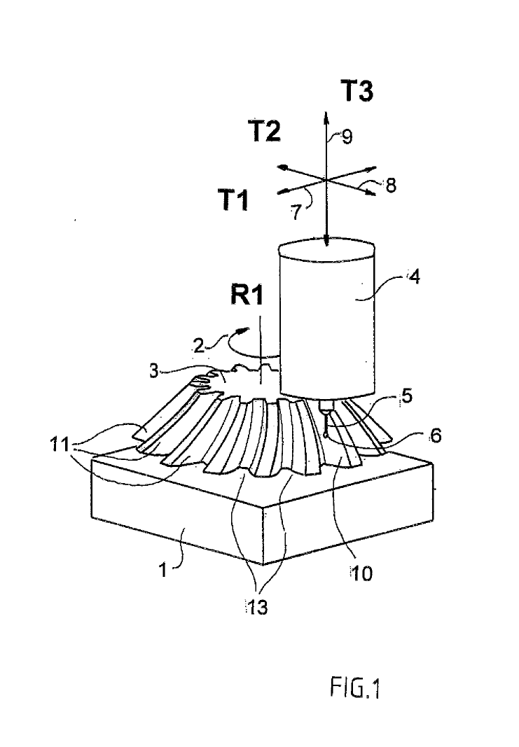

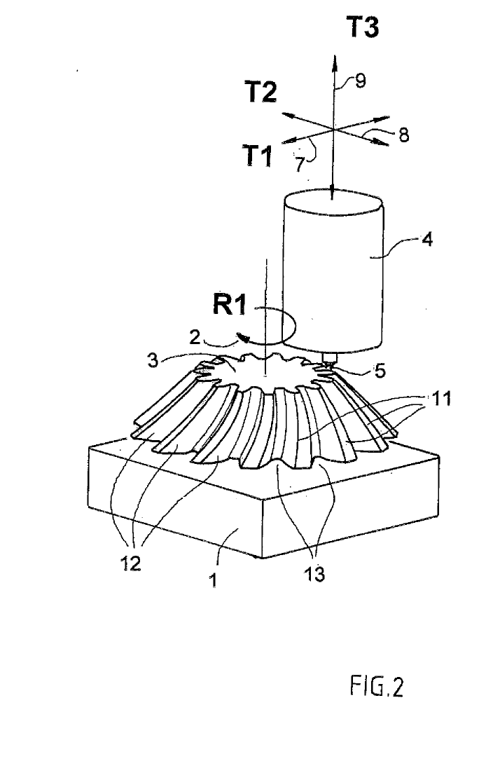

Such an approach is shown in the FIGS. 1 and 2 to be described hereinbelow, and is described in various publications by Figliolini, Özal and Suh:
Figliolini Giorgio (1); Angeles Jorge (2), “Algorithms for involute and octoidal bevel-gear generation”. Journal of mechanical design (J. mech.des.) ISSN 1050-0472 2005, vol. 127, no 4, pp. 664-672
S. H. Suh, D. H. Jung, E. S. Lee, “Modeling, implementation, and manufacturing of spiral bevel gears with crown”, International Journal of Advanced Manufacturing Technology, Springer-Verlag, Vol. 21, 2003, pp. 775-786.
S. H. Suh, et. Al, “Sculptured surface machining of spiral bevel gears”, International Journal of Machine Tool & Manufacture, Vol. 41, May, 2001, pp. 833-850.
S. H. Suh, W. H. Jih, H. D. Hong, D. H. Jung, “Manufacturing Spiral Bevel Gears with CNC milling”, Proceedings of the second International Conference on Advanced Manufacturing Technology, Johor-Bahru, Malaysia, pp. 261-267, 2000.
S. H. Suh, W. S. Jih, H. D. Hong, D. H. Jung, “Sculptured surface machining of spiral bevel gears”: a feasible study, 15^{th} ISPE/IEE International Conf. on CAD/CAM, Robotics, and Factories of the Future, Brazil, Vol.1, pp. 11-16, 1999.
Cihan Özel, Ali nan, and Latif Özal, “An Investigation on Manufacturing of the Straight Bevel Gear Using End Mill”. Journal of Manufacturing Science and Engineering—August 2005—Volume 127, Issue 3, pp. 503-511.

The authors describe the approach and results of performed experiments, which are based on the model which is translated into a machine code, with which a free and programmable, triaxial, simultaneously operating CNC machine is controlled.

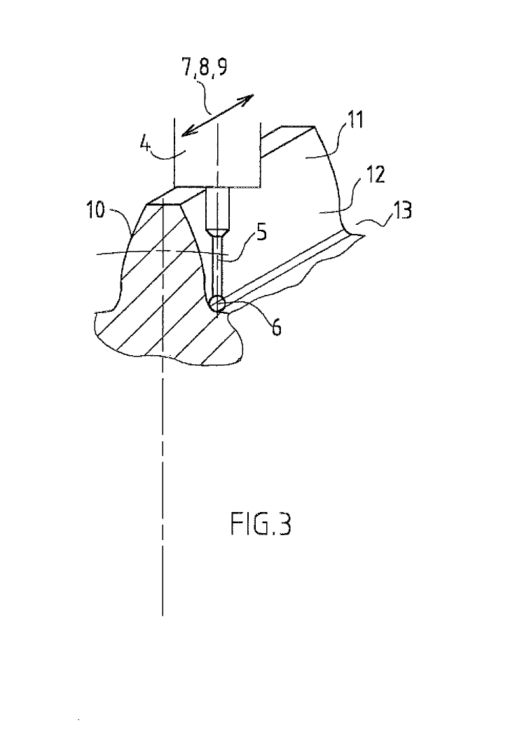

A drawback of this approach is that the diameter of the spherical milling device is limited by the smallest space between tooth flanks and possibly prescribed diameters of the tooth root, see also FIG. 3 to be described hereinbelow. The machining capacity of such a small spherical milling device is very low, whereby the milling time becomes very long, which results in the application of this method for wider commercial purposes having to be practically precluded.

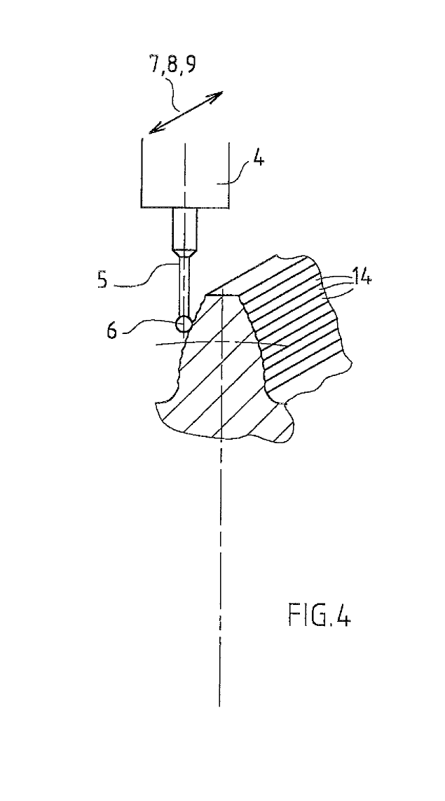

The milling with a small spherical milling device moreover leaves clear concave milling tracks, which results in a rough surface, or at least a surface with a smoothness leaving something to be desired. Mutually adjacent narrow, concave milling tracks sharply delineated by ridges are thus created on the tooth flank during milling. Reference is made in this respect to FIG. 4 to be described hereinbelow.

These milling tracks produce a rough tooth flank surface, which has a very adverse effect on the running properties and the lifespan of the gear, and whereby a number of the above stated requirements set for a high-grade gear transmission are not satisfied.

It thus takes longer in the case of rough tooth flanks before the co-acting gears wear into each other. A great deal of wear moreover occurs during wearing-in, wherein release of grinding dust into the gear transmission cannot be prevented, which is extremely undesirable.

The said wearing-in time therefore entails additional risks, such as bearing damage and tooth flank damage, or requires extra attention and cost, such as for oil filtering and monitoring. Moreover created in the case of two mutually co-acting gears as a result of the milling tracks are small contact surfaces with a greatly increased surface tension, with the danger of micro-pitting, i.e. material particles breaking out of the tooth surface, this resulting in accelerated wear.

The importance of achieving a very smooth tooth surface by milling is also highly significant from another viewpoint. If the desired definitive surface quality is obtained by milling, the necessity of applying the additional and expensive finishing by grinding usually required for this purpose is then dispensed with. With grinding as a finishing use would moreover have to be made of a likewise freely programmable milling machine, with the consequence of a likewise small spherical grinding stone. It will be apparent that grinding as finishing technique with such a small, spherical grinding stone is practically out of the question due to limitations in the field of rotation speed, loading and caking of the grinding disc. It is therefore necessary to resort to existing, machine-linked kinematic grinding techniques for the fine-grinding. The consequence hereof is that the prior art tooth form differs from the precise form of the spherical involute and therefore differs from the rough-milled tooth form, whereby the requirements set for a high-quality transmission are no longer satisfied, as briefly specified above.

For accurate and heavily loaded spherical involute gears this means that it is necessary to lay down the requirement for the milling process that an equally smooth and precisely defined surface can hereby be realized as is possible with fine-grinding.

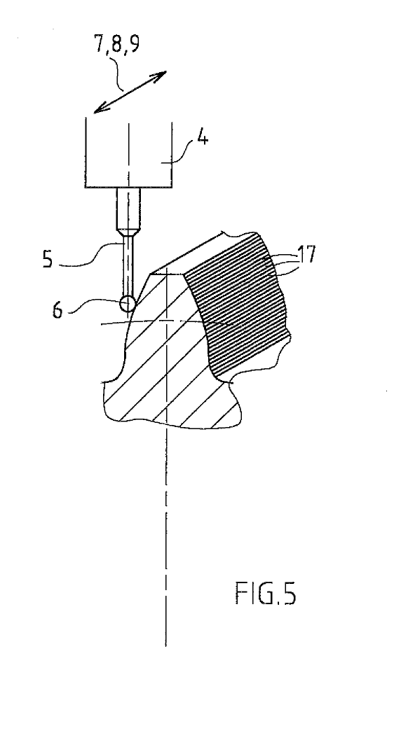

The adverse effect of said roughness can be partially countered by opting for very many milling movements. In this case the milling tracks may after all become very narrow, which enhances the smoothness of the tooth surface. It will however be apparent that, due to the many milling movements and the small machining volume per milling run, it takes even more time for a gear to be fully milled, even if use is made here of already rough-milled gears or preformed teeth on the basis of casting or other non-machining forming technique. Reference is made in this respect to FIG. 5 to be described hereinbelow.

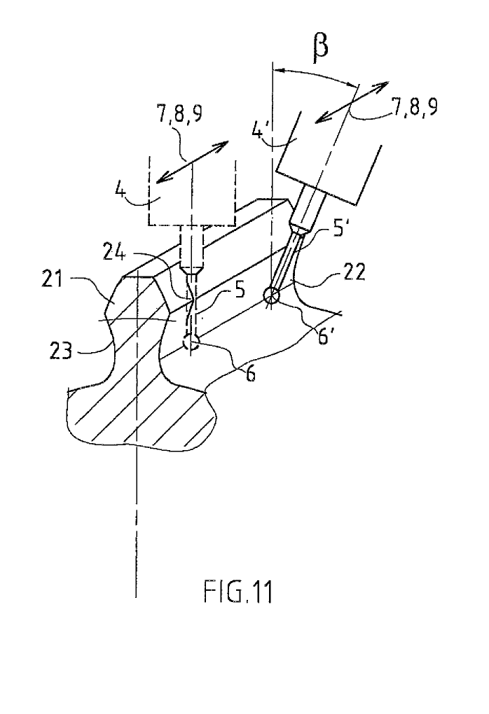

In addition, it has been found that it does not suffice in practice to apply only simple, freely programmable milling machines. It is thus found necessary to be able to vary the angle of the milling device within certain limits relative to the tooth flank. This is important in the case of an undercut tooth form, which may occur in the case of small cone angles and/or when the tooth direction has a sharp curve, see FIG. 11, which will be discussed hereinbelow.

This is also important because a spherical milling device has several positions which are inaccessible or unusable for milling purposes, such as the milling stem and the underside of the milling device, where the machining surfaces meet.

It must therefore be concluded from the foregoing that the above described technique, which is based on CNC milling with a triaxial or quadraxial milling machine in combination with a small spherical milling device, is not suitable for commercial practice.

Known from the article by H.-P. Schossig: “Auf einfachem Weg zu guten Zähnen”, Werkstatt and Betrieb, Carl Hanser Verlag, Munich, Germany, part 140, no. 4, pp. 28-32, ISSN 0043-2792, is a method for designing and manufacturing a gear by means of a computer-controlled machining device, for instance a cylindrical gear or a bevel gear, in particular a spiral bevel gear, which method comprises the following steps, to be performed in suitable sequence, of:

a) determining boundary and starting conditions on the basis of basic design requirements;

b) determining a basic design on the basis of these boundary and starting conditions with the assistance of a computer;

c) generating a basic machine code corresponding to this basic design;

d) including the results of steps (c) and (d) in the basic programme of the control computer;

e) causing the computer to generate a definitive machine code;

f) using a machining device adapted to perform an operation from the group including: milling and spark eroding;

g) using a tool, in particular a milling device or a spark erosion head; and

h) using a machining device of the type with at least five simultaneous, independent degrees of freedom.

In relation to the art which is discussed briefly in this article and which focuses particularly on the possibilities of manufacturing gears using machining tool machines with at least five simultaneous, independent degrees of freedom, it is an object of the invention to embody a method of the above specified type such that the surfaces modeled by machining can be manufactured with the same degree of smoothness in a shorter time, or the degree of smoothness can be improved substantially in the same amount of time, or a compromise can be realized between the two options.

With a view hereto the invention provides a method of the stated type which has the feature that

step (g) is performed with an elongate tool, the form of which corresponds at least to some extent with the intended form of surfaces for modeling by machining, in particular a concave form for modeling convex surfaces, a cylindrical form for modeling more or less flat or at least slightly convex surfaces, and a convex form for modeling more or less flat or at least slightly concave surfaces.

It will be apparent that more than six independent degrees of freedom are not possible, i.e. three of translation and three of rotation.

The tool is guided gradually and tilting in controlled manner along the surfaces for milling with at least one of the additional degrees of freedom relative to the literature.

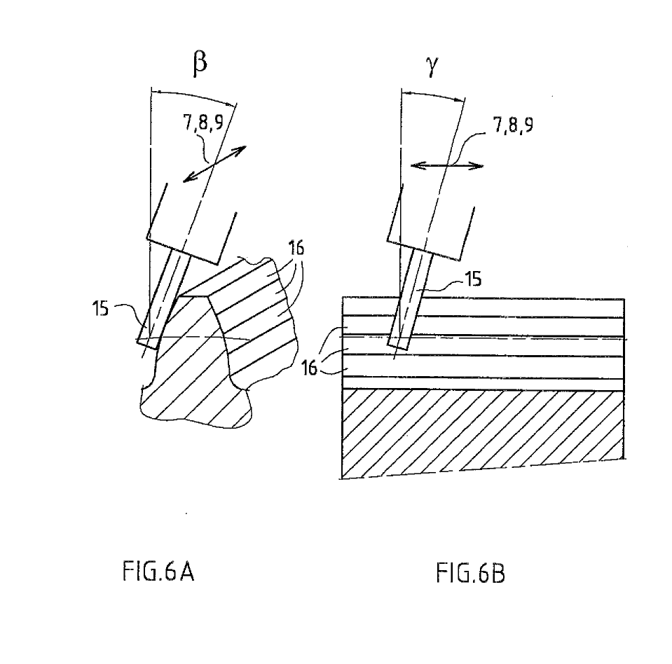

In an embodiment in which the tool has a cylindrical main shape an almost negligible roughness is realized, other than with a spherical milling device, by the elongate form of the tool despite relatively large pitch distances between the tracks of the scanning movement. See in this respect FIGS. 6A and 6B to be described hereinbelow.

In the case where the surface to be realized has a certain convexity, the method can have the special feature that the tool has a slightly concave main shape. The concave form of the tool must have a greater radius of curvature than the surface for forming.

In the theoretical case where a surface with a concave character must be formed, the method can have the special feature that the tool has a slightly convex main shape. In this case the radius of curvature of the concave surface of the tool must be smaller than that of the surface for forming.

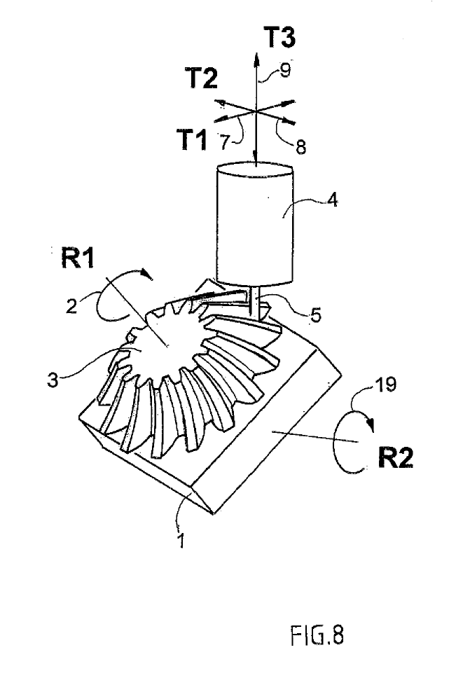

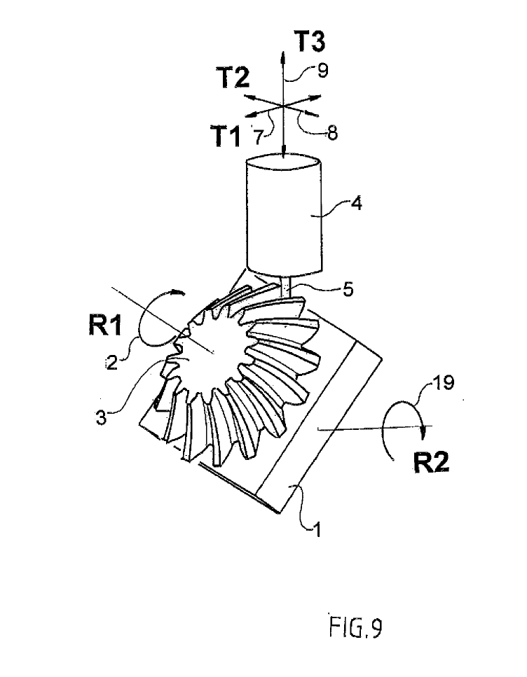

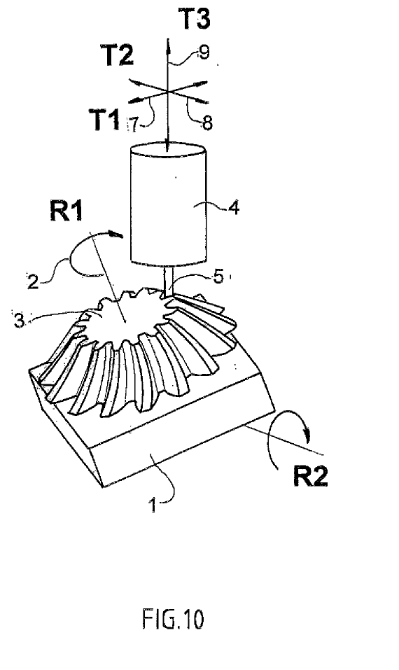

In an embodiment in which the free end zone of the tool has a convex main shape, particularly the valley between successive teeth can be readily accessed and modeled in accordance with the design requirements. Reference is made in this respect to FIGS. 8, 9 and 10, which will be discussed hereinbelow.

According to yet another aspect of the invention, the method comprises the steps of:

i) subdividing into phases the cycle of manufacturing a gear to be performed successively by the machining device, and assigning a specific tool to each phase; and

j) successively accommodating in the machining device the tools assigned to the various phases, measuring the relevant dimensions thereof by means of laser measuring means forming part of the machining device, and inputting these dimensions into the computer and then having step (i) performed by the computer such that the tool has at all times a desired nominal position.

Other than in the prior art, the invention is based on often more or less cylindrical or conical tools, in particular milling devices with straight or slightly concave flanks.

The advantage of such forms of tool is that, other than in the case of milling with a small spherical milling device, wide machining tracks are created which are flat or to a very slight extent spherical. At very small machining depths wide machining tracks, and thereby smooth surfaces, are thus also still obtained which are made up of line segments or of segments with considerably greater radii of curvature than in the case a spherical milling device of small diameter is applied.

In such a milling process the machining tool can have only one position relative to the double-curved surface of the tooth flank. This position is in any case dictated by the momentary angle of the tangent to the double-curved tooth surface. When making use of such a machining tool use must therefore be made of a machining device with at least five freely programmable axes, as according to the teaching of the invention. This is because, in addition to the position of the milling device in space, the position of the machining tool must also be defined relative to the tooth flank. A spatial angular positioning, thus two angles ∃, N, must therefore be added to the x-, y- and z-positionability options.

When applying cylindrical or conical machining tools with straight, slightly concave or slightly convex flanks, a machining device is therefore necessary which has available at least five programmable axes which can co-act simultaneously.

Because the same strict requirements in respect of the surface quality are not set for the tooth head and tooth root as for the tooth flank, these surfaces can for practical reasons be milled for instance with a different machining tool. This is the reason why a tool exchanger can in such cases be added to the freely programmable, quintaxial machining device. This can be partly prevented by embodying the milling device on its underside with a curve which corresponds with the rounding to be milled in the tooth root.

It will be apparent that, in respect of the complexity of controlling a quintaxial milling machine for the purpose of the complex three-dimensional tooth forms, such as of spiral bevel gears with cross-sections on the basis of a precise (spherical) involute, it is not possible to suffice with the existing mathematical models and machine codes.

The present invention combines the method for manufacturing bevel gears with spherical involute toothing by means of milling, on the basis of milling with more or less cylindrical or conical machining tools, with a straight, concave or convex jacket with a freely programmable, CNC-controlled, at least quintaxial milling machine, on the basis of a mathematical model which exactly describes the desired spherical involute tooth form, this model being translated into machine codes suitable for the complexity of the machine and the tooth form.

It is noted that Suh has succeeded in modeling a bevel gear according to a different method, probably by making use of a solid which is made using a three-dimensional CAD program with a module “gears” or “bevel gears”. These are both based on a mathematically in principle precisely described involute tooth form which is translated into a machine code for digitally programmable milling machines with a maximum of four degrees of freedom.

After being applied a number of times using an abrasive machining tool, for instance a rotating milling head, the method according to the invention is preferably recalibrated in order to prevent undesirable dimensional variations due to wear and to thus ensure the greatest possible accuracy of the gear to be manufactured. For this purpose the above described method can comprise the steps of:

k) measuring the relevant dimensions of the used tool by means of laser measuring means forming part of the machining device and inputting these dimensions into the computer; and

l) optionally causing the computer to generate a new machine code on the basis of the results of step (k) such that the tool takes up the nominal position, even in the case of possible dimensional variations, for instance as a result of wear.

According to a further aspect of the invention, the method according to the invention can comprise the following step of:

m) performing step (d) such that the operation to be performed in each relevant phase is carried out by the assigned tool in accordance with set requirements, for instance within the shortest possible time, with the smallest remaining surface roughness, with the smallest remaining deviations from the ideal form according to the definitive machine code, or the like.

The invention further relates to a gear obtained by applying a method as specified above.

The invention also relates to a machining device for manufacturing a gear with the method according to any of the above stated specifications, which device is of the type with at least five simultaneous independent degrees of freedom.

A practical embodiment of the method according to the invention can comprise the step

(n) of performing step (g) with a milling device with exchangeable bit plates. A part of the milling device, which is wearing and thus becoming increasingly blunter, can hereby be replaced, whereby it is expected that the tool costs will decrease.

The invention will now be elucidated on the basis of the accompanying drawings, in which the prior art and the invention are shown in highly schematic form.

In the drawings:

FIG. 1 shows a perspective view of a preformed gear which is carried by a rotatingly drivable turntable and which is modeled into its definitive form using the prior art method, wherein the turntable rotates initially in the rotation direction R1;

FIG. 2 shows a view corresponding to FIG. 1, wherein the turntable rotates in the rotation direction -R1;

FIG. 3 shows a cut-away perspective partial view of a gear for the purpose of elucidating the possibilities and limitations of the use of a spherical milling device;

FIG. 4 shows a view corresponding to FIG. 3 of the modeling of tooth flanks with a relatively great surface roughness;

FIG. 5 shows a view corresponding to FIG. 4 of the modeling of tooth flanks with a considerably smaller surface roughness;

FIG. 6A shows a view corresponding to FIGS. 3, 4, 5 and 5A making use of a cylindrical milling head;

FIG. 6B shows a side view of the tooth flank corresponding to the situation drawn in FIG. 6A;

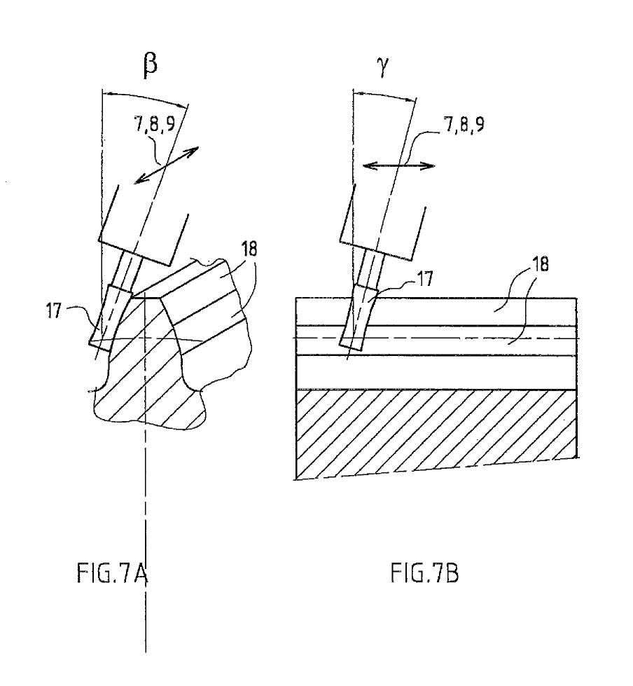

FIGS. 7A and 7B show views corresponding to FIGS. 6A and 6B, wherein use is made of a largely diabolo-shaped concave milling head for the manufacture of a convex tooth flank;

FIGS. 8, 9 and 10 show three views corresponding to FIGS. 1 and 2 in which, in addition to the indexed degree of freedom R1, a fifth degree of freedom of rotation R1 is added to the turntable as according to the teaching of the invention; and

FIG. 11 shows a view corresponding to FIG. 5 with tooth undercutting for the purpose of elucidating the necessity for a movable milling stem.

FIG. 1 shows a turntable 1 which is rotatable by means of drive means (not drawn) according to a degree of freedom R1, indicated with an arrow 2. Turntable 1 carries a preformed gear 3 which must be modeled into its definitive form.

Use is made for this purpose of a milling device 5 with a spherical head 6 driven rotatingly by a drive device 4. The stem of milling device 5 is thinner than the diameter of spherical head 6. By performing the necessary movements in accordance with the predetermined nominal form of the definitive gear, the three degrees of freedom of translation T1 (7), T2 (8) and T3 (9) are continuously adjusted by the computer during the machining process, in combination with the rotation movement R1 of turntable 1.

With rotation R1 the tooth flank 10 on the left in the drawing is processed by spherical head 5. This operation takes place for all corresponding tooth flanks of the teeth of gear 3, which for the sake of convenience are all designated 11.

FIG. 2 shows the situation in which the direction of rotation 2 is reversed, and thus corresponds to -R1. The right-hand tooth flanks 12 are hereby modeled.

FIGS. 1 and 2 show the principle of a triaxial, simultaneously operating prior art milling machine, wherein turntable 10 has a degree of freedom of rotation corresponding to a fourth, indexed degree of freedom.

FIG. 3 shows, also with reference to FIGS. 1 and 2, that spherical milling device 6 has such a small diameter that it also has a sufficiently great freedom of movement at the very bottom of tooth valley 13. It is noted here that, in the case of the spherical milling device applied here, the angle at which the milling stem 5 is directed relative to the relevant tooth or teeth 11 is not important, so that the position of milling device 4, 5, 6 is not relevant.

Attention is drawn to the fact that the diameter of the spherical milling device is bounded by the smallest nominal space at the bottom of tooth valley 13.

FIG. 4 shows that, with a relatively “crude” repeated scanning movement by milling head 6, the spherical milling device 6 leaves clearly delineated concave milling tracks 14.

FIG. 5 shows that it is possible, by selecting a short distance between the scanning tracks and thus a greater number of scanning movements, to opt for a greater number of considerably narrower and less deep milling tracks 17.

FIGS. 6A and 6B show schematically that milling tracks 16 are wide and smooth when use is made of an elongate, in this case cylindrical jacket milling cutter 15.

FIGS. 7A and 7B show that, with the use of a concave jacket milling cutter 17, an adequate approximation of the ideal tooth flank forms can in this case be realized with only two milling tracks 18.

FIGS. 8, 9 and 10 show the use of the three degrees of freedom of translation T1, T2 and T3 and two degrees of freedom of rotation R1 and R2 for modeling the tooth flanks.

Finally, FIG. 11 shows that a tooth 21 has undercut tooth flanks 22, 23. As shown schematically with broken lines, needle 5, which carries milling head 6, cannot access the undercut form. This is shown symbolically by drawing the sectional view through tooth flank 22 of milling stem 5. This section is designated with 24. Drawn with full lines is that the undercut form is however accessible by placing the milling device, designated here with 4′, 5′, 6′, at an angle ∃.

1-11. (canceled)

12. A method for designing and manufacturing a gear by means of a computer-controlled machining device, which method comprises the following steps, to be performed in suitable sequence, of:
a) determining boundary and starting conditions on a basis of basic design requirements;
b) determining a basic design on the basis of the boundary and starting conditions with the assistance of a computer;
c) generating a basic machine code corresponding to the basic design;
d) including results of steps (b) and (c) in a basic program of a control computer;
e) causing the computer to generate a definitive machine code;
f) using a machining device adapted to perform an operation selected from the group consisting of milling and spark eroding;
g) using a tool; and
h) using a machining device with at least five simultaneous, independent degrees of freedom;
wherein step (g) is performed with an elongate tool, which corresponds at least to some extent with an intended form of surfaces for modeling by machining.

13. The method as claimed in claim 12, wherein the manufactured gear is a spiral bevel gear.

14. The method as claimed in claim 12, wherein the tool comprises a milling device.

15. The method as claimed in claim 12, wherein the tool comprises a spark erosion head.

16. The method as claimed in claim 12, wherein the tool corresponds to a concave form for modeling convex surfaces.

17. The method as claimed in claim 12, wherein the tool corresponds to a cylindrical form for modeling more or less flat or at least slightly convex surfaces.

18. The method as claimed in claim 12, wherein the tool corresponds to a convex form for modeling more or less flat or at least slightly concave surfaces.

19. The method as claimed in claim 12, wherein the tool has a cylindrical main shape.

20. The method as claimed in claim 12, wherein the tool has a slightly convex main shape.

21. The method as claimed in claim 12, wherein the tool has a slightly concave main shape.

22. The method as claimed in claim 12, wherein the free end zone of the tool has a convex main shape.

23. The method as claimed in claim 12, further comprising the steps of
i) subdividing into phases manufacturing of a gear to be performed successively by the machining device, and assigning a specific tool to each phase; and
j) successively accommodating in the machining device the tools assigned to the various phases, measuring the relevant dimensions thereof by a laser measuring means forming part of the machining device, and inputting these dimensions into the computer and then performing step (i) by the computer wherein the tool has at all times a desired nominal position.

24. The method as claimed in claim 12, further comprising the step of:
k) measuring relevant dimensions of a used tool by means of laser measuring means forming part of the machining device and inputting the dimensions into the computer.

25. The method as claimed in claim 24, further comprising the step of:
l) causing the computer to generate a new machine code based on results of step (k), wherein the tool takes up a nominal position, in the case of possible dimensional variations as a result of wear.

26. The method as claimed in claim 12, further comprising the step of:
m) performing step (d) wherein the operation to be performed in a phase is carried out by an assigned tool in accordance with set requirements, wherein the set requirements are selected from the group consisting of within the shortest possible time, with the smallest remaining surface roughness, with the smallest remaining deviations from the ideal form according to the definitive machine code, and combinations thereof.

27. The method as claimed in claim 12, further comprising the step of:
n) performing step (g) with a milling device with exchangeable bit plates.

28. A gear obtained according to the method as claimed in claim 12.

29. A machining device for manufacturing a gear according to the method as claimed in claim 12, wherein the device comprises at least five simultaneous independent degrees of freedom.
